(19) United States
(12) Patent Application Publication
(10) Pub. No.: US 2002/0091872 A1
(43) Pub. Date: Jul. 11, 2002

(54) Virtualization of an integrated system across one or more computers

(76) Inventors: Erin M. Bourke-Dunphy, Seattle, WA (US); Jeff A. Zimniewicz, Bellevue, WA (US)

Correspondence Address: AMIN & TUROCY, LLP, 24TH FLOOR, NATIONAL CITY CENTER, 1900 EAST NINTH STREET, CLEVELAND, OH, 44114, US

(21) Appl. No.: 09/725,382

(22) Filed: Nov. 29, 2000

(51) Int. Cl. G06F 9/00; G06F 9/46

(52) U.S. Cl. 709/316

(57) ABSTRACT

A data structure is created to store information that characterizes a virtual system. The virtual system includes one or more computer and application components resident on such computers. The data structure stores information about the infrastructure and/or configuration associated with the computer(s) and each of the application components in the virtual system, such that installation and/or management of such components may be facilitated.

### TECHNICAL FIELD

The present invention relates to computer programming and, more particularly, to a system and method for virtualizing an integrated system across one or more computers.

### BACKGROUND

As businesses become increasingly reliant on a variety of computer software in its day-to-day business activities, it is incumbent upon software companies to provide products that appeal to the needs of its customers. One common approach is for a software company to group applications and/or services into packages, commonly referred to as “suites.” Typically, software companies license suites at a reduced cost when compared to the cost of purchasing each of the applications or services separately. Different applications and/or services may be packaged into different suites targeted to different types of customers. A common requirement of suite licenses is that the applications and/or services of the suite must be installed on a single computer.

It is increasingly common for businesses of various sizes to utilize multiple servers within its business organization. One or more servers may be physically located at the corporate central office. Additional servers further may be located at remote locations. All of such servers may form part of a single corporate domain. By way of illustration, a server at the central location may include a database server and server management components, while another server may include connectivity components, and yet another server includes firewall components. Various other scenarios may be utilized according to the needs of a particular organization.

Utilizing multiple servers in a corporate organizational structure provides several advantages when applications and services are installed diversely. Such advantages may include improved security, reliability, and scalability. In order to legally utilize applications and/or services in the context of conventional licenses, however, individual copies of the applications and/or services should be purchased for each machine on which they are to be installed. Even if a “paper” license permits installation of components across multiple machines, the administrator or other person installing the components usually must manually determine which components are to be installed on which machines. After the components have been installed, there is no underlying infrastructure that integrates the components within the organization. The separate installation further fails to provide an infrastructure that facilitates management of and/or access to the individual components, such as other applications that may require use of different ones of the installed components.

### SUMMARY

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention provides a system and method to facilitate installation and management of related application components across one or more computers. An object is created at one of the computers to store information that characterizes a virtual system. The virtual system includes one or more computers and application and/or service components resident on such computers. The object may store information about the infrastructure and/or configuration associated with the computer(s) and each of the components installed in the virtual system. The computers are interconnected so that each may access the stored configuration data of the object.

The object may store the configuration data in a data structure that facilitates integration of the components. By way of example, the data structure may include a system field that identifies the virtual system. A computer field is operable to identify each of the computers within the virtual system. A component field is associated with each computer field to identify application components installed in each respective computer of the virtual system. The respective fields further may include associated attributes identifying further characteristics thereof. According to one particular aspect, the fields of the data structure may be objects.

In accordance with a particular aspect of the present invention, an installation component is operable to access the object to control installation of the application components at each of the computers. For example, the installation component may limit the installation of each particular component, such that only a single instance of one or more components is installed in the virtual system. In addition, the installation component may control the number of computers that form a virtual system in accordance with an aspect of the present invention.

One aspect of the present invention provides a system to facilitate installation and management of application and/or service components. The system includes a setup component operable to create and/or modify a data structure for storing information that defines a virtual system formed of at least one computer. The setup component controls membership to the virtual system based on the stored information.

Another aspect of the present invention provides a computer-readable medium having computer-executable instructions for creating an object at one of a plurality of computers and storing in the object: (a) infrastructure information about a virtual system defined by at least one of the plurality of computers; and (b) configuration information associated with each application component installed in the virtual system.

Yet another aspect of the present invention provides a data structure. The data structure includes a group object for characterizing a virtual computer system. The group data object includes at least one computer object for identifying at least one computer in the virtual computer system. The computer object includes a component object for characterizing application and/or service components resident on the at least one computer.

Still another aspect of the present invention provides a method to facilitate installation and management of application and/or service components. The method includes creating an object and storing information about a virtual system that includes at least one computer. Installation of application and/or service components in the virtual system is controlled based on the information stored in the object.

Another aspect of the present invention relates to a data packet adapted to be transmitted between at least two processes. The data packet comprises a data structure for storing information that defines a virtual system formed of at least one computer. The data packet may also comprise a setup component for controlling membership to the virtual system based on the stored information.

To the accomplishment of the foregoing and related ends, certain illustrative aspects of the invention are described herein in connection with the following description and the annexed drawings. These aspects are indicative, however, of but a few of the various ways in which the principles of the invention may be employed and the present invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 is a simplified block diagram of a virtual system implemented within a networking environment in accordance with the present invention;

FIG. 2 is a functional block diagram of a network domain, illustrating an aspect of the infrastructure for a virtual group in accordance with the present invention;

FIG. 3 is block diagram illustrating an example of a data structure for a group object in accordance with the present invention;

FIG. 4 is an example of a user interface for associating a computer with a virtual group in accordance with the present invention;

FIG. 5 is an example of a user interface for associating components with a virtual group in accordance with the present invention;

FIG. 6A is an example of a graphical user interface for selecting components for a virtual group in accordance with the present invention;

FIG. 6B is another example of a graphical user interface for selecting components for a virtual group in accordance with the present invention;

FIG. 7 is an example of an operating environment for a system implemented in accordance with the present invention;

FIG. 8 is a flow diagram illustrating a methodology for adding a computer to a virtual group in accordance with the present invention;

FIG. 9 is a flow diagram illustrating another methodology for adding a computer to a virtual group in accordance with the present invention; and

FIG. 10 is a flow diagram illustrating a methodology for installing components onto a computer of a virtual group in accordance with the present invention.

### DESCRIPTION OF THE INVENTION

The present invention provides a system and method for virtualizing a group of application and/or service components across one or more computers. Information that defines the virtual group may be stored as a data structure. The data structure may be employed to facilitate and/or enforce desired installation requirements for components being installed on computers within the virtual group.

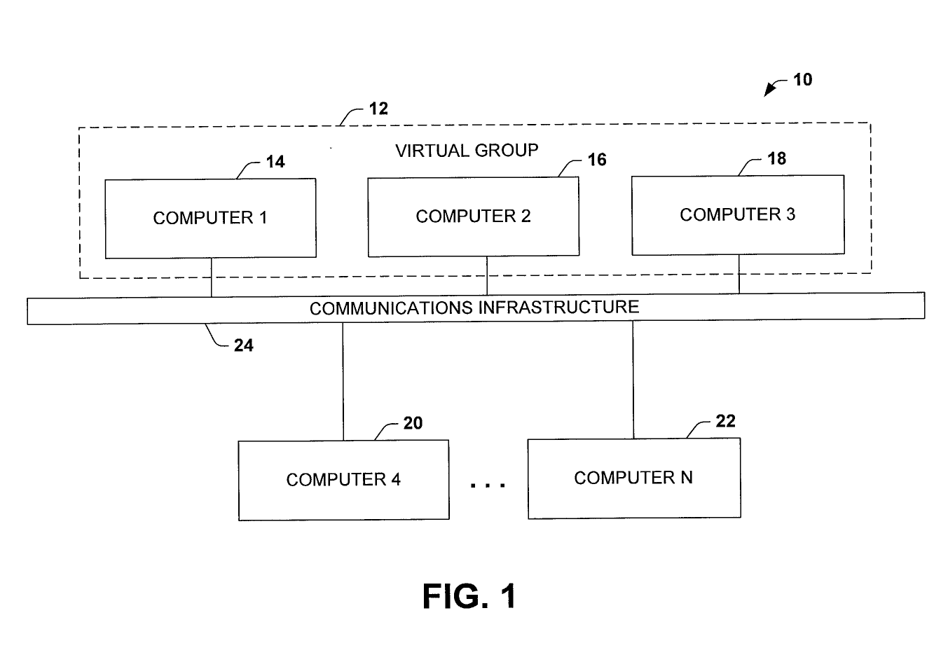

FIG. 1 illustrates an example of a networking environment 10 which may be programmed and/or configured to implement a virtual computer group 12 in accordance with an aspect of the present invention. The virtual group 12 is formed of one or more computers 14, 16, and 18 and provides functionality defined by the application and/or server components installed within the group 12.

The networking environment 10 includes a plurality of computers 14, 16, 18, 20, and 22, such as may be servers, interconnected via a communications infrastructure 24. The communications infrastructure may include one or more Local Area Networks (LANs) and/or Wide Area Network (WANs). At least the computers 14, 16, and 18 within the virtual group 12 form part of a common network domain, although all computers 14-22 in the environment may be part of the same domain. By way of example, some of the computers may be directly coupled to each other via a direct data connection, such as a LAN (e.g., telephone, DSL, Cable Modem, wireless data communications, ISDN, etc.) and/or through a WAN through a corresponding associated communications path, such as may include the Internet.

A data structure defines the characteristics of the virtual group 12, such as identifying the computers in the virtual group and the application and/or service components resident in each identified computer. The data structure may be populated during a setup procedure in which computers in the virtual group 12 and/or the components are being installed. The data structure, for example, is stored in one of the computers 14 in the virtual group 12. It is to be understood and appreciated that, in accordance with an aspect of the present invention, the data structure could be stored at any computer(s) of the networking environment 10 accessible by the computers of the virtual group 12.

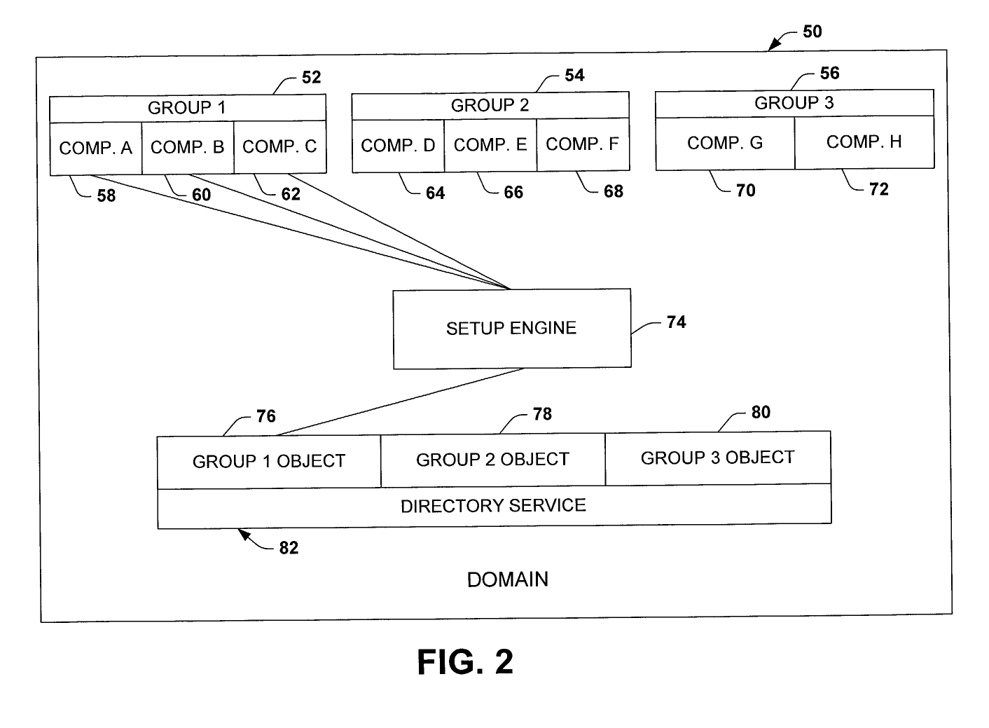

FIG. 2 is a representation of a network domain 50 having a plurality of virtual groups 52, 54, and 56. Each virtual group 52, 54, 56 includes one or more respective computers 58, 60, and 62; 64, 66, and 68; and 70 and 72. In accordance with an aspect of the present invention, a setup engine 74 populates a group object 76, 78, 80 associated with each respective virtual group 52, 54, 56. The group objects 76, 78, and 80 contain data that tracks installation characteristics associated with each respective virtual group 52, 54, 56. The group objects 76, 78, and 80 may be stored in a directory 82, such as at one of the computers 58-72 of the domain 50. A group object container may be created, for example, the first time a setup procedure is completed or the first time an appropriately configured planning tool is run. The group object container may include one or more group objects 76, 78, and 80 in accordance with an aspect of the present invention.

By way of example, the group objects 76, 78, and 80 may stored in a distributed directory service, such as an extension of the “Active Directory™” directory service provided by the Microsoft Corporation of Redmond, Wash. Another example of a distributed directory is the “Novell Directory Services™”, which is based on the X.multidot.500 network services protocol developed and published by the Open Systems Interconnection Consortium. Information on a distributed directory may be created, read, modified, and shared by other nodes in a network infrastructure, such as client nodes or other server nodes, which have applicable access rights to the distributed directory.

By way of further illustration, the setup engine 74 is resident on a domain computer (e.g., the computer 58) to which some or all of the application components are to be installed. The setup engine 74 collects information during installation, such from the user (e.g., via user-prompted interfaces) or a system registry of the computer 58. The information identifies the computer 58 to which the component or components are being installed. The setup engine 74 also collects information indicative of the application components and subcomponents that are to be installed on the computer 58.

The setup engine 74 further may be programmed to control the installation of application components at each of the computers in the group 52. That is, the setup engine 74 may access the group object 76 and control (e.g., selectively restrict) installation of components at the computer 58 based on the information stored in the associated group object 76. For example, the setup engine might limit the number of instances (e.g., one instance of selected components) for each application component installed in a virtual group. The setup engine 74 also may notify a user about potential problems or conflicts that may exist during installation or setup.

According to one particular aspect, the computers 58, 60, and 62 may be added to the virtual group 52 during separate parts of an installation procedure in which selected components are installed at the computers. During each part of the installation procedure, an instance of setup engine 74 may run on each computer 58, 60, 62 performing the functions described herein.

It is to be understood and appreciated that, alternatively, the installation of components may be conducted from one computer in a virtual group, with selected components being installed at each other computer remotely via the communications infrastructure that interconnects the computers. The setup engine performs substantially the same functions, but with the installation/setup being facilitated because the entire setup procedure is implemented from a single machine.

By extending the infrastructure within the domain 50, the present invention is able to also extend an installation and/or setup beyond the boundary of a single computer to the computer in each virtual group. As a result, the present invention helps integrate the components installed into each virtual group, as defined by the respective group objects 76, 78, and 80, such that installation and/or management of such components is facilitated.

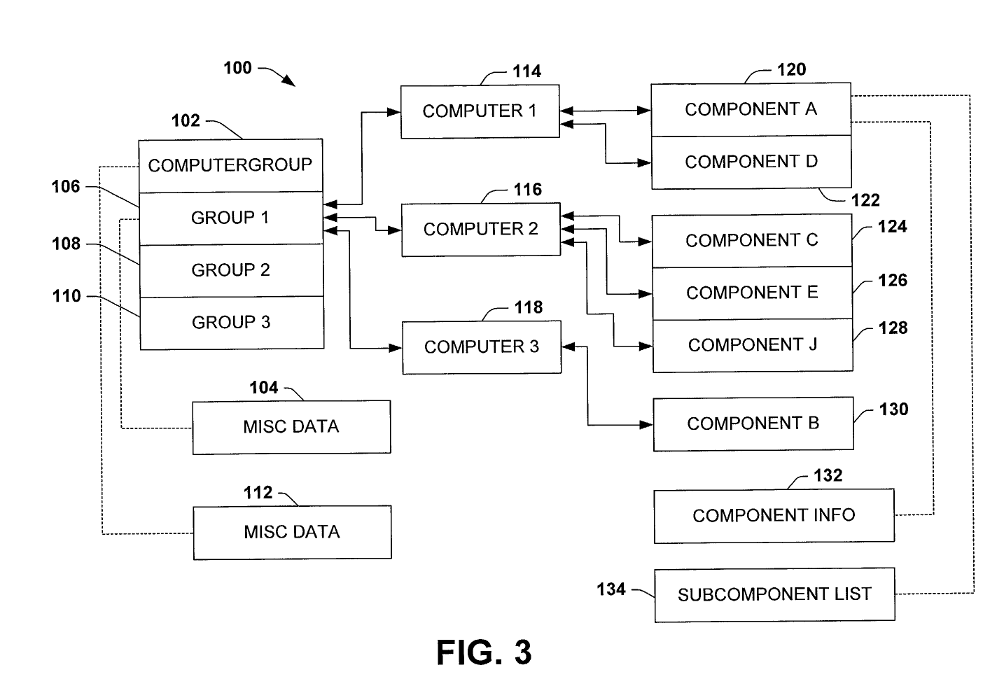

FIG. 3 illustrates an example of a group object container data structure 100, in accordance with an aspect of the present invention, such as may be stored in a directory service. As mentioned above, the group object 100 contains information indicative of each virtual group in the domain, identifying data for each computer in each virtual group, and components installed on each computer. The setup engine may employ appropriate executable code to append the group object data structure to an appropriate directory service. The executable code typically is utilized once during deployment of the virtual system to create the group object container in the domain, subsequent to which the setup engine may amend the group object data structure. Other executable also may be employed to modify or update the group object. Suitable graphical user interface components, such as dialog boxes, may be associated with the executable instructions to indicate confirmation and/or progress for the creation and update to the group object data structure 100.

Referring back to the example of FIG. 3, the group object data structure 100 includes an object 102 called COMPUTERGROUP of a corresponding class type (e.g., of type computerGroupManager). The COMPUTERGROUP object 102 may be utilized, such as by a setup engine or other applications, to access the individual group objects that form the data structure 100. The COMPUTERGROUP object 102 further may have one or more properties, such as may include a MISCDATA property 104. The MISCDATA property 104, for example, is a mulit-valued string property that may be used to store selected information in connection with the COMPUTERGROUP object 102. By way of example, the MISCDATA property 104 maps a Global Unique Identifier (GUID) to each item of string data provided.

The COMPUTERGROUP object 102 includes one or more children objects 106, 108, and 110 named “[Group Name] COMPUTERGROUP” of type computerGroup. By way of example, the Group Name object may identify the first computer (e.g., server) added to the virtual group. Each Group Name object (e.g., the Group1 object 108), which identifies a corresponding virtual group of computers, also may include a MISCDATA property 112 for storing selected information in connection with the Group Name object, such as by mapping a Global Unique Identifier (GUID) to each item of string data provided.

Under each Group Name object (e.g., GROUP1 object 108), are objects named COMPUTER1 114, COMPUTER2 116, AND COMPUTER3 118 of type computerGroupComputer for identifying each computer (e.g., server) in the virtual group, such as may be identified by the computer's name. For purpose of brevity, only the computers associated with GROUP1 are illustrated in FIG. 3. It is to be appreciated that each group object may be similarly configured, in accordance with an aspect of the present invention.

Information indicative of the application and/or service components (e.g., the top level components) are organized as objects 120, 122, 124, 126, 128, and 130 under the respective computer objects 114, 116, 118 onto which they are installed. The component objects 120-130, for example, are indicated by name and are of type serverComponent. By way of illustration, components 120 and 122 are installed on the COMPUTER1 114, components 124, 126, and 128 are installed on COMPUTER2 116, and component 130 is installed on COMPUTER2 118.

Each of the components 120-130 further may include two properties, namely, COMPONENT INFO 132 and SUBCOMPONENT LIST 134. The COMPONENT INFO 132 property may be used to store information about the high level component itself. The SUBCOMPONENT LIST 134 property is a multi-valued property for identifying the subcomponents of each component.

An example of the group object data structure for GROUP1 of FIG. 3, assuming a domain of foo.ms.com, is as follows:

LDAP://dc=foo,dc=ms,dc=com

CN=COMPUTERGROUPS

CN=GROUP1 COMPUTERGROUP

CN=COMPUTER1

CN=COMPONENTA
CN=COMPONENTD

CN=COMPUTER2

CN=COMPONENTC
CN=COMPONENTE
CN=COMPONENTJ

CN=COMPUTER3

CN=COMPONENTB

It is to be appreciated that, in accordance with an aspect of the present invention, any number of groups may be implemented within a given domain. In addition, any number of components may be installed onto each computer within the virtual group, in accordance with an aspect of the present invention.

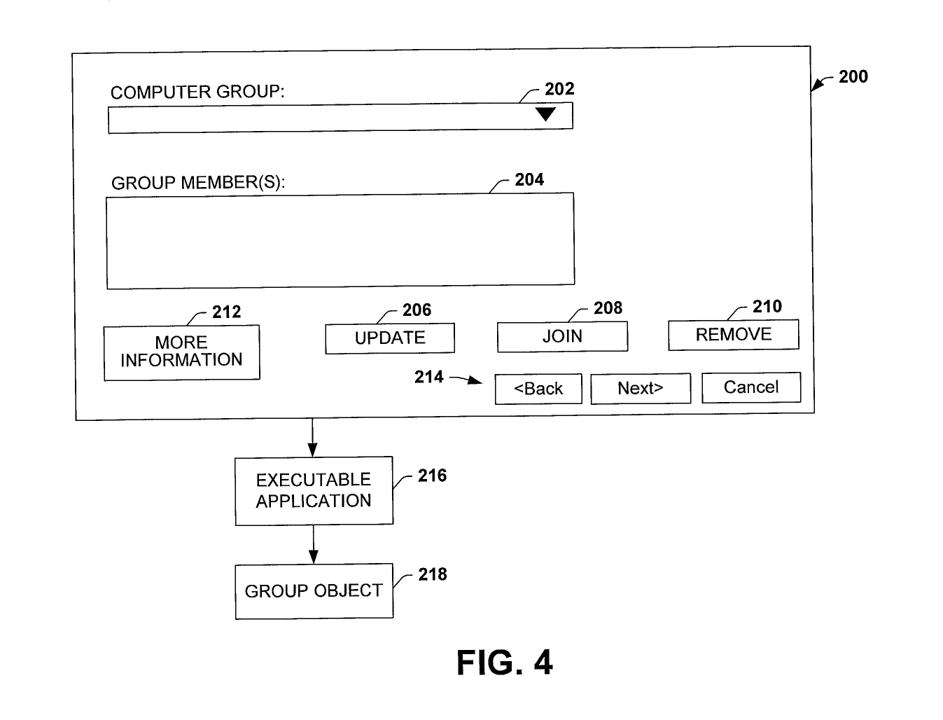

FIG. 4 illustrates an example of user interface 200 that may be utilized to create and/or modify member characteristics of a virtual group in accordance with an aspect of the present invention. The interface 200, for example, may be employed during the installation of components onto a computer.

The interface 200 includes a user interface element 202, such as may include a drop down menu, for selecting a computer group of which the user wishes the present computer to become a member. Accordingly, it is presumed that, at this stage, the user has already created a group object having at least one virtual group. Typically, a user has an option to add the computer to an existing virtual group or to create a new virtual group. A list of the members of the group selected at 202 is displayed in a display area 204. The user also may select one or more members in the display area for performing selected actions.

For example, the interface 200 may include an UPDATE button 206 for updating a group object, a JOIN button 208 for adding a computer to a virtual group, and a REMOVE button removing an existing member from a selected virtual group. Another action button 212 is provided for obtaining additional information about a selected virtual group or member thereof. Other action buttons 214 may be provided for navigating through available setup and installation menus.

The interface component 200 is operatively associated with an executable component 216 for programming an appropriate group object 218, such as may be arranged as shown in FIG. 3. The executable component 216, for example, is programmed to access a directory service where the group object is stored and to modify member characteristics of the group object 218 based on the information provided from the interface component 200. That is, data (e.g., computer name and associated attributes thereof) may be provided to the group object 218 via the executable component 216 upon selecting the JOIN action button 208 of the interface 200. Similarly, data may be removed from the group object 218 upon selecting a member in the display 204 and activating the REMOVE button 210. If a group object has not yet been created, however, the executable component 216 may create the object, such as an extension to an existing directory service.

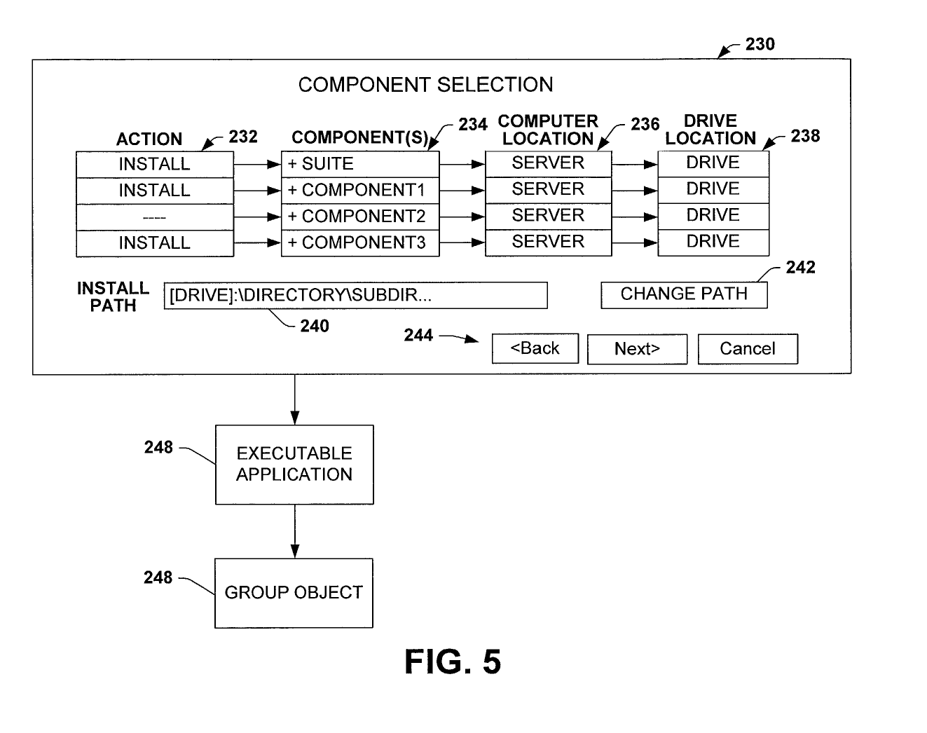

FIG. 5 illustrates an example of a component selection interface 230 for selecting components to be installed in a virtual group in accordance with an aspect of the present invention. The component selection interface 230 may be utilized as part of an installation procedure, such for a computer that has become a member of a virtual group (e.g., see FIG. 4).

The component selection interface 230 includes a user interface element 232, for selecting a desired action to perform with respect to each available component for a given virtual group. In particular, each interface element 232 maps to an associated interface element 234 for indicating what action is to be performed with respect to an associated component (e.g., whether or not the component is to be installed). The user interface element 234 also may include drop down menu for displaying subcomponents of the respective components. In this way, a hierarchy of the available components and subcomponents may be shown to the user, from which a user may selectively install each component.

The user interface 230 further may be programmed to ensure that interdependent components are installed when a user selects to install one component. By way of example, if a user attempts to install one component (or subcomponent) but chooses not to install a necessary associated component or subcomponent, the interface may notify the user of such requirement. The interface also may automatically select to install such dependent components (e.g., by default) according to the user selections.

Each component display user interface element 234 is associated with a computer location user interface element 236. The computer location interface elements 236 provide a selectable list (e.g., by drop down menu) of the computers within a given virtual group, indicating where a user has selected the components to be installed. The interface element 236 also may identify locations (e.g., by computer name) within a virtual group where other components have been installed. Associated with each computer location interface element 236 is a drive location user interface element 238 for selecting a particular drive on a respective computer where the user desires to install a selected component.

The installation path for a selected component may be indicated in an installation path field 240. A user may change the path by activating an associated change path action button 242. The component selection interface 230 may include other action buttons, generally indicated at 244, for navigating through available setup and installation menus.

The component selection interface 230 is operatively associated with an executable component 246 for programming an appropriate group object 248. The executable component 246, for example, is programmed to access the directory service where a group object 248 is stored. The executable component 248 is operable to append or modify component characteristics of a given member computer in the group object 248 based on the information provided from the interface component 230.

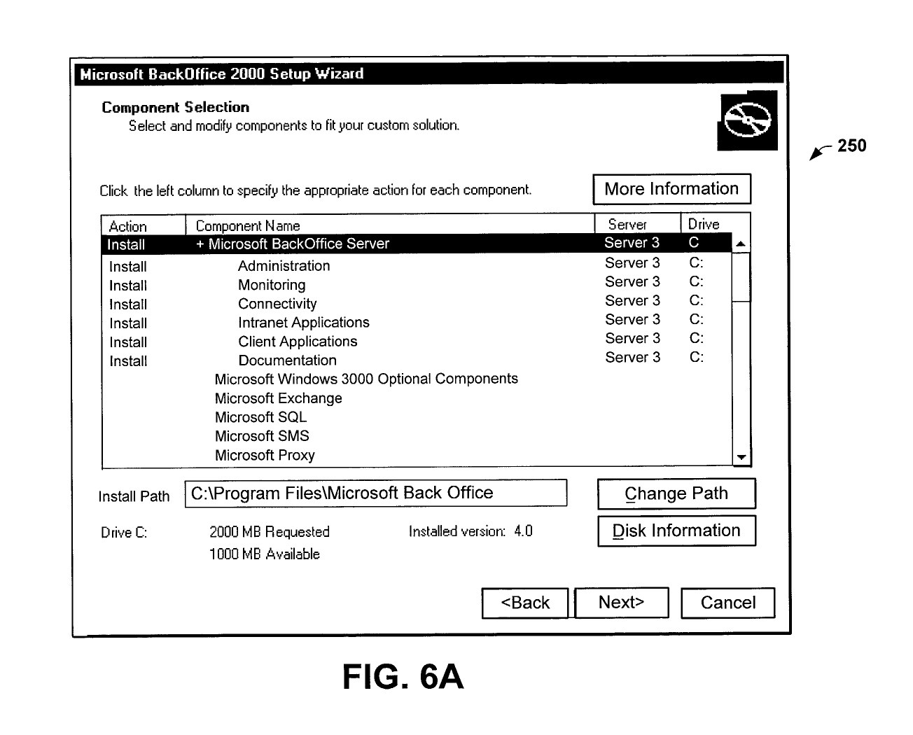

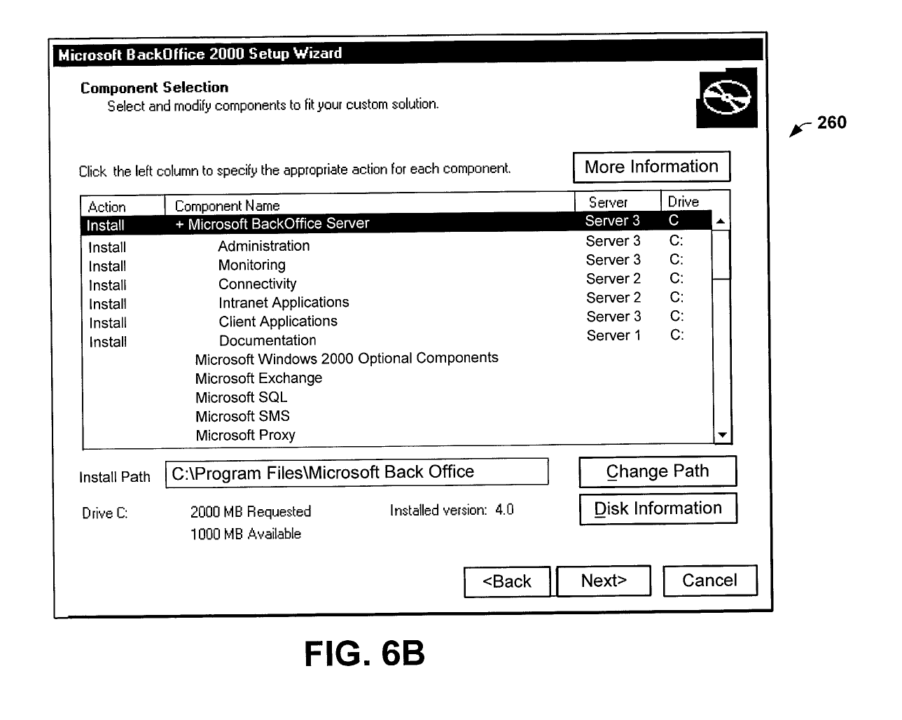

FIG. 6A illustrates an example of graphical user interface 250 programmed and/or configured for component selection in accordance with an aspect of the present invention. In this example, the interface 250 is being employed to selectively install server-related application components. It is to be understood and appreciated by those skilled in the art that the present invention is equally applicable to facilitate integration, installation, and/or management of other types of components, such as for non-server components and/or components for web-based services.

Moreover, the group object created, in accordance with an aspect of the present invention, may be utilized by other applications to facilitate their installation. For example, it may be desirable to access the group object during installation of other applications and/or services to determine on which computer (or which virtual group) certain components are installed. In this way, such other applications and/or services may target installation to one or more computers to capitalize on the resources installed on such computers.

FIG. 6B illustrates another example of a graphical user interface 260 that may be implemented, in accordance with an aspect of the present invention, for selecting components for installation. In this particular example, the installed components have been flagged as being installed on different servers in an associated virtual server system. While in this example, the components have been installed on three different servers, it is to be appreciated that any number of computers may form a virtual system in accordance with an aspect of the present invention. A user may employ the user interface 260 to select one or more of the uninstalled components to install them on one of the computers of the virtual system, as described herein.

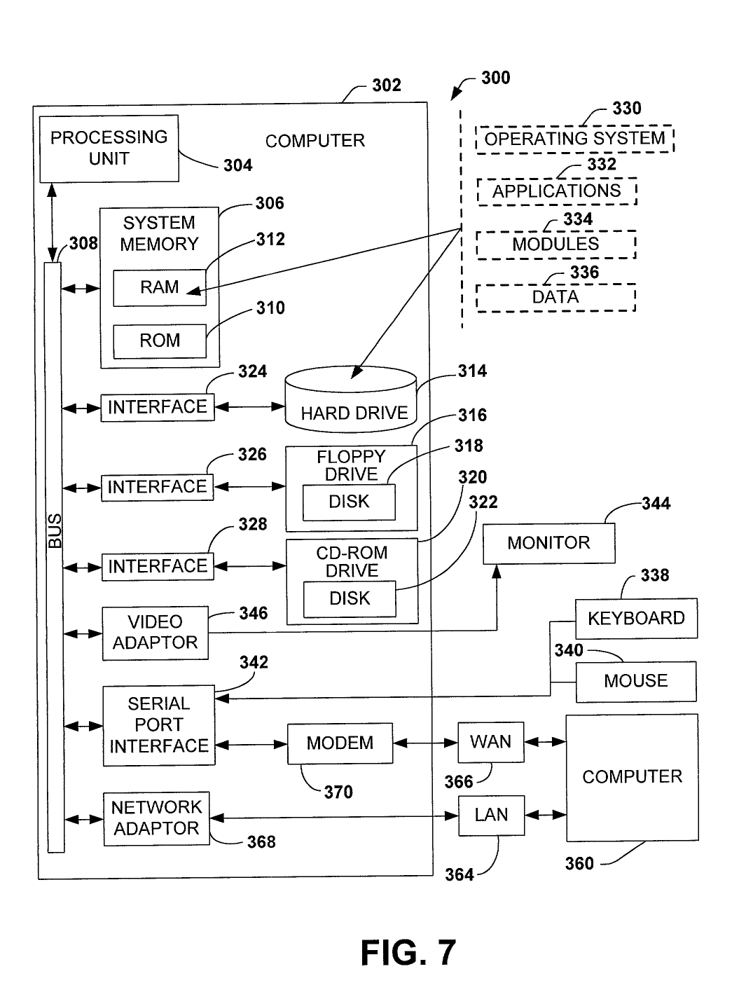

In order to provide additional context for the various aspects of the present invention, FIG. 7 and the following discussion are intended to provide a brief, general description of a suitable computing environment 300 in which the various aspects of the present invention may be implemented. While the invention has been described above in the general context of computer-executable instructions of a computer program that runs on a local computer and/or remote computer, those skilled in the art will recognize that the invention also may be implemented in combination with other program modules. Generally, program modules include routines, programs, components, data structures, etc. that perform particular tasks or implement particular abstract data types. Moreover, those skilled in the art will appreciate that the inventive methods may be practiced with other computer system configurations, including single-processor or multiprocessor computer systems, minicomputers, mainframe computers, as well as personal computers, hand-held computing devices, microprocessor-based or programmable consumer electronics, and the like, each of which may be operatively coupled to one or more associated devices. The illustrated aspects of the invention may also be practiced in distributed computing environments where certain tasks are performed by remote processing devices that are linked through a communications network. However, some, if not all, aspects of the invention may be practiced on stand-alone computers, with the present invention facilitating expansion and growth to multiple computers. In a distributed computing environment, program modules may be located in both local and remote memory storage devices.

With reference to FIG. 7, an exemplary system environment 300 for implementing the various aspects of the invention includes a computer 302, such as a server. The computer 302 includes a processing unit 304, a system memory 306, and a system bus 308 that couples various system components including the system memory to the processing unit 304. The processing unit 304 may be any of various commercially available processors, including but not limited to Intel x86, PENTIUM and compatible microprocessors from Intel and others, including Cyrix, AMD and Nexgen; ALPHA microprocessors from Digital; MIPS microprocessors from MIPS Technology, NEC, IDT, Siemens, and others; and the POWERPC microprocessors from IBM and Motorola. Dual microprocessors and other multi-processor architectures also may be used as the processing unit 304.

The system bus 308 may be any of several types of bus structure including a memory bus or memory controller, a peripheral bus, and a local bus using any of a variety of conventional bus architectures such as PCI, VESA, Microchannel, ISA, and EISA, to name a few. The system memory includes read only memory (ROM) 310 and random access memory (RAM) 312. A basic input/output system (BIOS), containing the basic routines that help to transfer information between elements within the computer 302, such as during start-up, is stored in ROM 310.

The computer 302 also may include, for example, a hard disk drive 314, a magnetic disk drive 316, e.g., to read from or write to a removable disk 318, and an optical disk drive 320, e.g., for reading from or writing to a CD-ROM disk 322 or other optical media. The hard disk drive 314, magnetic disk drive 316, and optical disk drive 320 are connected to the system bus 308 by a hard disk drive interface 324, a magnetic disk drive interface 326, and an optical drive interface 328, respectively. The drives and their associated computer-readable media provide nonvolatile storage of data, data structures, computer-executable instructions, etc. for the computer 302. Although the description of computer-readable media above refers to a hard disk, a removable magnetic disk and a CD, it should be appreciated by those skilled in the art that other types of media which are readable by a computer, such as magnetic cassettes, flash memory cards, digital video disks, Bernoulli cartridges, and the like, may also be used in the exemplary operating environment 300, and further that any such media may contain computer-executable instructions for performing the methods of the present invention.

A number of program modules may be stored in the drives and RAM 312, including an operating system 330, one or more application programs 332, other program modules 334, and program data 336. The operating system 330 in the illustrated computer is, for example, one of the MICROSOFT WINDOWS® operating systems, which are available from Microsoft Corporation. It is to be appreciated, however, that the present invention may be implemented with other operating systems or combinations of operating systems.

A user may enter commands and information into the computer 302 through one or more user input devices, such as a keyboard 338 and a pointing device (e.g., a mouse 340). Other input devices (not shown) may include a microphone, a joystick, a game pad, a satellite dish, a scanner, or the like. These and other input devices may be connected to the processing unit 304 through a serial port interface 342 that is coupled to the system bus 308, although such devices may be connected by other interfaces, such as a parallel port, a game port, a universal serial bus (USB), etc. A monitor 344 or other type of display device is also connected to the system bus 308 via an interface, such as a video adapter 346. In addition to the monitor 344, the computer 302 may include other peripheral output devices (not shown), such as speakers, printers, etc.

As mentioned above, the computer 302 may operate in a networked environment using logical connections to one or more other computers 360, such as may form part of a common network domain. The remote computer 360 may be a workstation, a server computer, a router, a peer device or other common network node, and typically includes many or all of the elements described relative to the computer 302. The logical connections depicted in FIG. 7 may include a local area network (LAN) 364 and a wide area network (WAN) 366. Such networking environments are commonplace in offices, enterprise-wide computer networks, intranets and the Internet.

When used in a LAN networking environment, the computer 302 is connected to the local network 364 through a network interface or adapter 368. When used in a WAN networking environment, the computer 302 typically includes a modem 370, or is connected to a communications server on the LAN, or has other means for establishing communications over the WAN 366, such as the Internet. The modem 370, which may be internal or external, is connected to the system bus 308 via the serial port interface 342 (e.g., for communications over POTS). The modem alternatively may be connected to the system bus 308 via the network interface or adapter 368 (e.g., for communication over DSL, cable, satellite, etc.). In a networked environment, program modules depicted relative to the computer 302, or portions thereof, may be stored in the remote memory storage device. It will be appreciated that the network connections shown are exemplary and other means of establishing a communications link between the computers 302 and 360 may be used.

In accordance with the practices of persons skilled in the art of computer programming, the present invention has been described with reference to acts and symbolic representations of operations that are performed by a computer, such as the computer 302 or remote computer 360, unless otherwise indicated. Such acts and operations are sometimes referred to as being computer-executed. It will be appreciated that the acts and symbolically represented operations include the manipulation by the processing unit 304 of electrical signals representing data bits which causes a resulting transformation or reduction of the electrical signal representation, and the maintenance of data bits at memory locations in the memory system (including the system memory 306, hard drive 314, floppy disks 318, CD-ROM 322) to thereby reconfigure or otherwise alter the computer system's operation, as well as other processing of signals. The memory locations where such data bits are maintained are physical locations that have particular electrical, magnetic, or optical properties corresponding to the data bits.

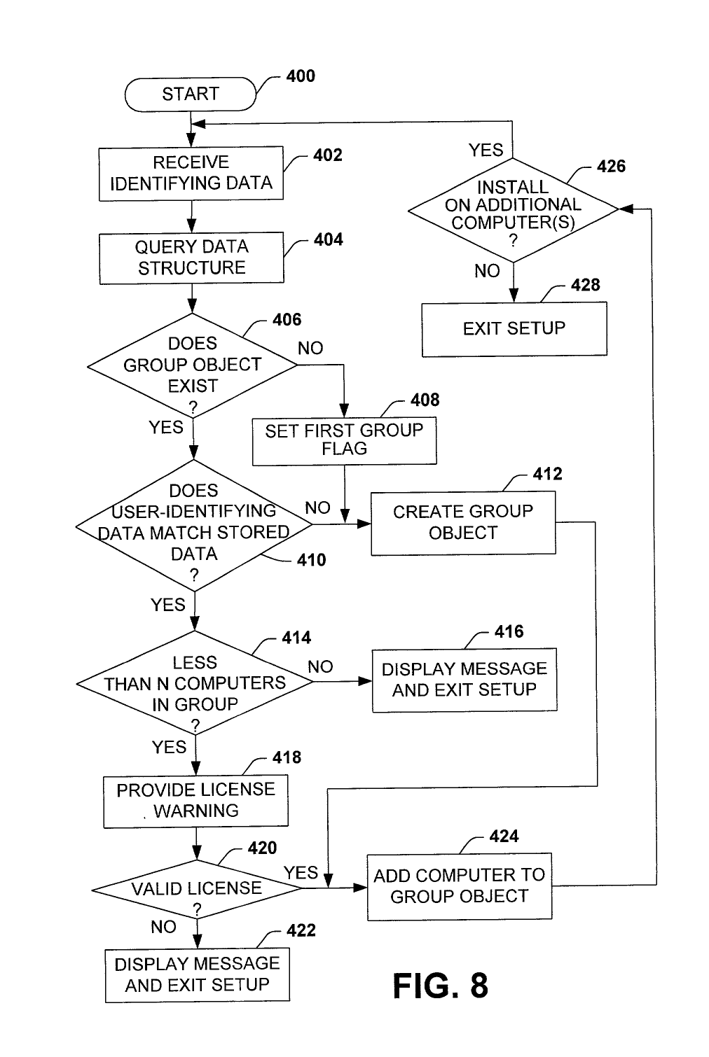

In view of the foregoing structural, functional, and graphical features described above, methodologies in accordance with various aspects of the present invention will be better appreciated with reference to FIGS. 8, 9 and 10. While, for purposes of simplicity of explanation, the methodologies of FIGS. 8-10 are shown and described as a series of steps, it is to be understood and appreciated that the present invention is not limited by the order of steps, as some steps may, in accordance with the present invention, occur in different orders and/or concurrently with other steps from that shown and described herein. Moreover, not all illustrated steps may be required to implement a methodology in accordance with an aspect the present invention.

FIG. 8 illustrates a methodology for adding computers to a virtual group object in accordance with an aspect of the present invention. The methodology begins at step 400 in which operating parameters are initialized. This may coincide, for example, with beginning an installation procedure for a plurality of related application and/or service components (e.g., a package or suite of components). The process proceeds to step 402 in which identifying data is received. The identifying data, for example, may correspond to a serial number or other information (e.g., a product key value) provided with the application programs being installed. The user may enter the identifying information during an initial part of the installation procedure. Next, at step 404, a database is queried. The database, for example, may be a directory service in which data associated with the virtual groups of a common network domain (e.g., a group object) exists. The query returns data indicative of the member in component characteristics of the group object. From step 404, the process proceeds to step 406.

At step 406, a determination is made as to whether a group object exists, such as based on the query results. If the no data is returned or a negative result is provided in response to the query (step 404), the process proceeds to step 408. At step 408, a FIRST GROUP flag is set, thereby indicating that no group object has been created in the directory service. If the determination at step 406 is affirmative, indicating that a group object does exist, the process proceeds to step 410. At step 410, a determination is made as to whether the identifying data (step 402) matches identifying data stored in connection with the group object. If the determination at step 410 is negative, indicating the absence of a match, the process proceeds to step 412. From step 408, the process also proceeds to step 412. At step 412, a group object is created. If the FIRST GROUP flag has been set at step 408, a process may be implemented to appropriately extend the directory service to include a group object container, such as of the type shown in FIG. 3.

If the determination at step 410 is affirmative, indicating a match between the identifying data, the process proceeds to step 414. By detecting a match between the identifying data in an existing group object and that associated with software being installed, the methodology, in accordance with an aspect of the present invention, may force subsequent installations of the same software into a common virtual group.

At step 414, a determination is made as to whether there are less than ‘n’ computers in the group associated with the identifying data, where ‘n’ is a positive integer (e.g., n=3). If there are not less than ‘n’ computers in the group, the process proceeds to step 416. At step 416, a message is displayed indicating, for example, an improper installation, and the setup is exited. This may correspond to a situation in which the software being installed is licensed for ‘n’ computers, but the user is attempting to install the same software on more than ‘n’ computers in a given domain. As a result, the installation interface is programmed to exit setup and not permit the n+1th copy to be installed. The identifying data thus may further be employed to limit the number of installations of the same software in the virtual group. If the determination at step 414 is affirmative, indicating that there are less than ‘n’ computers in the group associated with the identifying data, the process proceeds to step 418.

At step 418, a license warning is provided. The license warning, for example, may indicate that in order to legally proceed with the installation, the user requires a valid software license. Next, at step 420, a determination is made as to whether there is a valid license. For example, the determination may simply upon the user affirmatively indicating that the user has a valid license for the computer on which the software is being installed (e.g., by selecting a corresponding box in a user interface). Alternatively or additionally, the determination may include verifying that each copy of the software installed in a given domain has a proper license, such as by comparing identifying data stored in the group object with identifying data of the software being installed. If it is determined that there is not a valid license, the process proceeds to step 422. At step 422, a message is displayed, such as indicating that the user must acquire a valid license from the software vendor, and the setup procedure is exited. If the determination at step 420 is affirmative, indicating a valid license, the process proceeds to step 424. Also, from step 412, after a group object has been created, the process proceeds to step 424. As a result, the methodology, in accordance with an aspect of the present invention facilitates compliance with licensing requirements of the software being installed.

At step 424, a computer (e.g., of type computerGroup) is added to the appropriate group of the group object. From step 424, the process proceeds to step 426 in which a determination is made as to whether the software is to be installed on any additional computers. This determination, for example, may require the user physically taking the software for installation at another remote computer or, alternatively, the installation software may prompt the user for installing the software remotely on another computer. If the software is to be installed on other computers, the process returns to step 402. Prior to beginning installation onto other computers, baseline operations may be performed to ensure proper interconnectivity between the computers that are to be added to the virtual group. However, if the software is not to be installed on other computers, the process proceeds to step 428 in which the setup is exited.

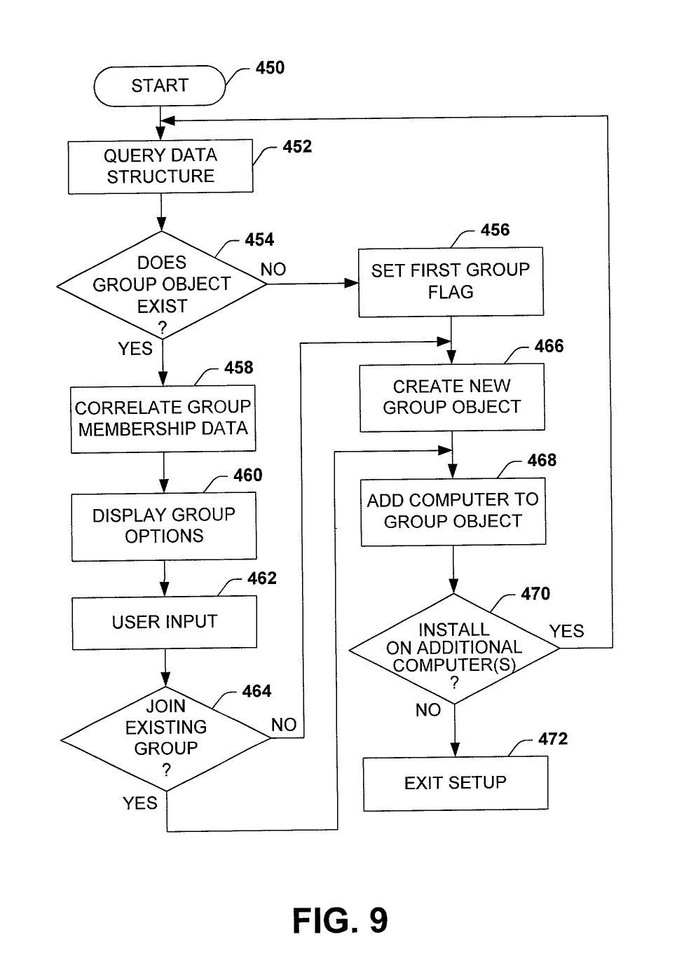

FIG. 9 illustrates another methodology for adding one or more computers to a group object in accordance with an aspect of the present invention. The methodology begins at step 450 in which operating parameters are initialized, such as upon beginning an installation procedure for application and/or service components. The process proceeds to step 452 in which a database is queried, such as a directory service associated with a given network domain in which the software is being installed. The process then proceeds to step 454 in which a determination is made as to whether a group object exists. If the determination is negative, indicating that no group object exists, the process proceeds to step 456 in which a FIRST GROUP flag is set. A FIRST GROUP flag indicates that no group object exists in the database that was queried (step 452). If the determination at step 454 is affirmative, indicating that a group object does exist, the process proceeds to step 458. At step 458, group membership data from the group object is correlated. This may include, organizing the group data in a desired format. Next, at step 460, the correlated group membership options are displayed. The group options may include a request for whether the user wishes to join an existing group (provided that an existing group has a vacancy) or whether the user desires to create a new group. The group options further may include displaying a list of all groups and members within such groups. From step 460, the process proceeds to step 462.

At step 462, a user input is received based on a selection from the group options displayed at step 460. Next, at 464, a determination is made as to whether the input indicates that the computer on which the software is being installed is to join an existing group. If the determination is negative, the process proceeds to step 466. Similarly, from step 456, the process proceeds to step 466. At step 466, a new group object is created. If the first group flag was set at step 456, an executable process is implemented for creating a container in which the group object is stored. From step 466 and from step 464, if the determination is affirmative, the process proceeds to step 468. At step 468, the computer is added to the selected group of the group object, such as by appending the group object to identify the computer. From step 468, the process proceeds to step 470.

At step 470 a determination is made as to whether the software is to be installed on any additional computers. If the determination is affirmative, the process proceeds to step 470 in which the process is repeated. If the software is not to be installed on additional computers, the process proceeds to step 472 in which the setup is exited. It is to be appreciated, however, that rather than exiting setup, another part of the installation procedure may be implemented in accordance with an aspect of the present invention.

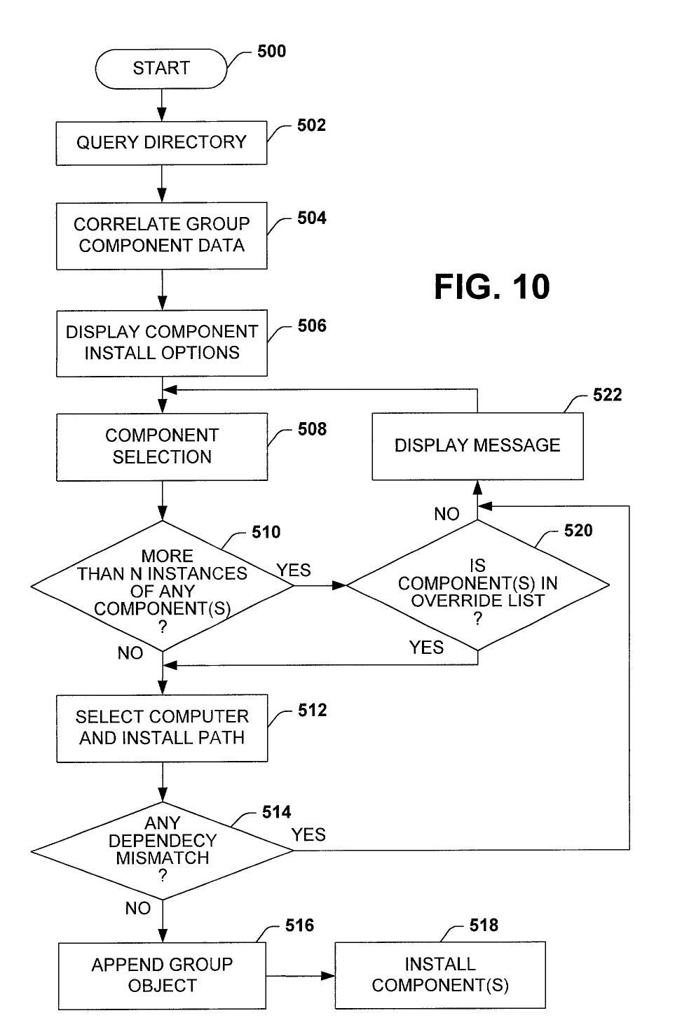

FIG. 10 illustrates another aspect of a setup and/or installation procedure in accordance with an aspect of the present invention. In particular, FIG. 10 illustrates a methodology for installing components onto a computer that has already been added to a virtual group, such as disclosed above with respect to FIGS. 8 and 9. The methodology begins at step 500 in which appropriate parameters are initialized and an installation component, which may include an appropriate setup manager and/or an integration tool kit, is activated. Next, at step 502, a database is queried, such as the directory service in which the group object is stored. The query returns group component and member data, which are correlated at step 504. The correlation may include organizing the data to facilitate a meaningful display to the user. Next, at step 506, component installation options are displayed to the user, such as through a suitable graphical user interface (e.g., see FIGS. 5 and 6). The process then proceeds to step 508, in which component selections are made. The component selections, for example, may include: selecting whether to install a particular component and/or subcomponent thereof; selecting the location of the computer on which each component or subcomponent is to be installed; and/or selecting the drive location and directory of the drive where such components are to be installed. From step 508, the process proceeds to step 510.

At step 510, a determination is made as to whether the user is attempting to install more than a ‘n’ instances of one or more components, where ‘n’ is a positive integer (e.g., n=1). If the determination is negative, indicating that the number of instances of a component being installed is less than ‘n’, the process proceeds to 512. At step 512, in the computer and installation path for the selected components are selected. Next, at step 514, a determination is made as to whether there is any dependency mismatch. A dependency mismatch may exist, for example, when a user attempts to install a component or a subcomponent on a computer that is different from a computer on which an interdependent component has been or is selected to be installed. If there is no dependency mismatch the process proceeds to step 516.

At step 516 the group object is appended to include an identification of components and subcomponents for each component that the user selected. Next, at step 518, the selected components are installed. If the determination back at step 510 is affirmative, indicating that the user has attempted to install more than the permitted number of instances of a given component, the process proceeds to 520. At step 520, a determination is made as to whether the component(s) that has been selected to be installed more than is normally permitted in a virtual group is in a component override list. The component override list may identify certain components for which more than ‘n’ instances of selected components may be installed within the virtual group. For example, it may desirable to install certain application and/or service components on each computer in a virtual group. If the determination at step 520 is negative, indicating that the component is not in the override list, the process proceeds to 522.

At step 522, an appropriate message is displayed to the user indicating that more than the permitted number of instances of a particular component has been selected for installation within a virtual group. Alternatively or additionally, the component selection interface may not permit a user to select more than instance of such components for installation. From step 522, the process returns to step 508 for additional component selections.

If the determination back at step 520 is affirmative, indicating that the component is in the override list, the process proceeds to step 512. As mentioned above, at step 512 the computer or the component(s) is to be installed and the installation path are selected. Next, a determination is made as to whether there is any dependency mismatch (step 514). If this determination is affirmative, the process proceeds to step 522 in which a message is provided to indicate the occurrence of such a mismatch and provide the user with alternative options. Alternatively or additionally, the component selection interface may be designed such as to inhibit the occurrence of dependency mismatches, such as by automatically imposing certain interdependencies between components during installation.

What has been described above includes exemplary implementations of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. A system to facilitate installation and management of application components, comprising:
a setup component operable to at least one of create and modify a data structure for storing information that defines a virtual system formed of at least one computer, the setup component controlling membership to the virtual system based on the stored information.

2. The system of claim 1, wherein the at least one computer comprises a plurality of computers.

3. The system of claim 2 wherein at least some of the plurality of computers are servers.

4. The system of claim 2 wherein each of the plurality of computers in the virtual system are interconnected within a common network domain.

5. The system of claim 4, wherein the data structure is stored as an object in a directory service of the network domain.

6. The system of claim 1, wherein membership to the virtual system is limited to a predetermined number of computers.

7. The system of claim 6, wherein the setup component is operable to modify the data structure to store a plurality of group objects, each group object defining a different one of a plurality of virtual systems.

8. The system of claim 7, wherein each of the plurality of virtual systems further comprises at least one computer, each of the computers in the plurality of virtual systems being interconnected within a common network domain.

9. The system of claim 7, wherein each group object further includes identifying data for identifying an associated computer-readable medium having computer-executable instructions, the setup component controlling each installation of the computer-executable instructions of the associated computer readable medium to one of the virtual systems based on the identifying data.

10. The system of claim 1, wherein the setup component further comprises a component selection component for controlling installation of application or service components to the at least one computer in the virtual system based on the information stored in the data structure.

11. The system of claim 10, wherein the component selection component is operable to limit the number of instances of at least one of the application or service components installed within the virtual system based on information stored in the data structure.

12. The system of claim 11, wherein the component selection component is operable to limit the installation of at least one of the application or service components to a single instance within the virtual system.

13. The system of claim 1, wherein the data structure further comprises a group object for characterizing the virtual system, the group object including at least one computer object for identifying the at least one computer of the virtual system, the computer object including at least one component object for characterizing the components resident on the at least one computer.

14. A computer-readable medium having computer-executable instructions for:
creating an object at a first of a plurality of computers; and
storing in the object (a) infrastructure information about a virtual system defined by at least one of the plurality of computers and (b) configuration information associated with application or service components installed in the virtual system.

15. The computer-readable medium of claim 14 having further computer-executable instructions for accessing the object and controlling installation of additional components to the virtual system based on information stored in the object.

16. The computer-readable medium of claim 15 having further computer-executable instructions for controlling the number of instances of each of the components installed within the virtual system based on information stored in the object.

17. The computer-readable medium of claim 15 having further computer-executable instructions for limiting installation of at least one selected component to a single instance within the virtual system.

18. The computer-readable medium of claim 14, wherein the virtual system comprises a plurality of computers interconnected within a common network domain.

19. The computer-readable medium of claim 18, wherein the object is stored in a directory service of the network domain.

20. The computer-readable medium of claim 14 having further computer-executable instructions for limiting membership to the virtual system to a predetermined number of computers based on the information stored in the object.

21. The computer-readable medium of claim 20 having further computer-executable instructions for modifying the information stored in the object to include a plurality of group objects, each group object defining a different one of a plurality of virtual systems.

22. The computer-readable medium of claim 21, wherein each of the plurality of virtual systems is part of a common network domain.

23. The computer-readable medium of claim 21, wherein each group object further includes identifying data for identifying an associated set of computer-executable instructions, the computer-readable medium having further computer-executable instructions for controlling each installation of the associated set of computer-executable instructions based on the identifying data.

24. A computer-readable medium having computer executable instructions for defining a data structure comprising:
a group object for characterizing a virtual computer system, the group object including at least one computer object for identifying at least one computer in the virtual computer system, the computer object including a component object for characterizing application or service components installed on the at least one computer.

25. The computer-readable medium of claim 24, wherein the component object includes at least one property for characterizing information about at least one of the components and subcomponents thereof installed on the at least one computer.

26. The computer-readable medium of claim 24, wherein the data structure further comprises a plurality of group objects, each characterizing a different virtual computer system.

27. The computer-readable medium of claim 24, wherein the data structure is stored in a directory service of a network domain, whereby, upon accessing the data structure, installation and management of components within the network domain is facilitated.

28. A system to facilitate installation and management of application or service components, comprising:
means for creating an object at one of a plurality of interconnected computers; and
means for storing in the object (a) infrastructure information about a virtual system defined by at least one of the plurality of computers and (b) configuration information associated with the components installed in the virtual system.

29. A method to facilitate installation and management of application or service components, comprising:
creating an object for storing information about a virtual system that includes at least one computer;
storing in the object infrastructure information about the virtual system; and
controlling installation of application or service components in the virtual system based on the information stored in the object.

30. The method of claim 29, further comprising controlling the number of instances of each of the components installed within the virtual system based on information stored in the object.

31. The method of claim 30, further including limiting installation of at least one selected component to a single instance thereof within the virtual system.

32. The method of claim 29, wherein the virtual system comprises a plurality of computers interconnected within a common network domain.

33. The method of claim 32, wherein the step of storing further comprises storing the object in a directory service of the network domain.

34. The method of claim 29, further comprising limiting membership to the virtual system to a predetermined number of computers based on the information stored in the object.

35. The method of claim 29, further comprising modifying the information stored in the object to include a plurality of group objects, each group object defining a different one of a plurality of virtual systems in a common network domain.

36. The method of claim 35, wherein each group object further includes identifying data for identifying an associated computer-readable medium having computer-executable instructions, the method further comprising controlling a location to where the computer-executable instructions are installed based on the identifying data.

37. The method of claim 36 wherein the step of controlling installation of the computer-executable instructions further includes controlling each installation of the computer-executable instructions, such that the computer-executable instructions of the associated computer readable medium are installed in one of the virtual systems.

38. A data packet adapted to be transmitted between at least two processes, comprising:
a data structure for storing information that defines a virtual system formed of at least one computer.

39. The data packet of claim 38, comprising:
a setup component for controlling membership to the virtual system based on the stored information.

40. An information signal adapted to be transmitted between at least two processes, comprising computer-executable instructions for storing information that defines a virtual system formed of at least one computer.

41. The information signal of claim 40, wherein the at least two processes are on different computers.
